(19) United States
(12) Patent Application Publication
(10) Pub. No.: US 2012/0088200 A1
(43) Pub. Date: Apr. 12, 2012

(54) FURNACE HEAT EXCHANGER

(75) Inventor: Paul M. Haydock, Zionsville, IN (US)

(73) Assignee: CARRIER CORPORATION, Farmington, CT (US)

(21) Appl. No.: 13/247,382

(22) Filed: Sep. 28, 2011

Related U.S. Application Data
(60) Provisional application No. 61/391,406, filed on Oct. 8, 2010.

(51) Int. Cl. F27D 17/00; F28F 9/00

(52) U.S. Cl. 431/202; 165/47

(57) ABSTRACT

A primary heat exchanger for a furnace includes one or more passes and having a heat exchanger height. A ratio of heat exchanger efficiency to heat exchanger height is in the range of about 7.0 points per inch to about 8.1 points per inch. A furnace includes a burner for combusting a fuel and a primary heat exchanger operably connected to the burner. The primary heat exchanger includes one or more passes and has a heat exchanger height. A ratio of heat exchanger efficiency to heat exchanger height is in the range of about 7.0 points per inch to about 8.1 points per inch.

### CROSS-REFERENCE TO RELATED APPLICATIONS

This application claims priority to U.S. provisional application, 61/391,406, filed Oct. 8, 2010, the entire contents of which are incorporated herein by reference. This Application is technically related to Application 61/296,505 filed on Jan. 20, 2010 which is herein incorporated by reference.

### BACKGROUND OF THE INVENTION

The subject matter disclosed herein relates to furnaces. More specifically, the present disclosure relates to heat exchanger configurations for furnaces.

In a typical furnace, a fuel, for example, natural gas, is combusted in a burner. The combustion gas, flue gas, is routed through one or more heat exchangers which extract the heat therefrom. In a condensing gas furnace there are two types of heat exchangers: a primary heat exchanger (PHX) and a secondary or condensing heat exchanger (CHX). Most of the efficiency of a furnace is tied directly to the efficiency of the PHX. Thus increasing the efficiency of the PHX is a cost-effective way to increase the efficiency of the entire furnace. The PHX reduces the heat of the flue gas from the flame to a temperature well above the dew point temperature of the water in the flue gas. The flue gas heats the surface of the PHX and air is blown across the exterior of the PHX thus removing heat from the PHX by convection. Efficiency is measured by the amount of heat energy that is transferred out of the flue gas compared to the amount of heat energy that is available by the flue gas. It can be determined roughly by knowing how much air and gas enters and is burned in the PHX, and the temperature of the gas leaving the PHX. The CHX makes up the remainder of the furnace efficiency by reducing the flue gas temperature and by condensing moisture from the flue gas into liquid water and thus taking advantage of the latent heat energy.

Efficiency of the furnace is typically increased by increasing the size, or height, of the heat exchanger. As shown in FIG. 1, efficiency tends to have a linear relationship with heat exchanger height. Typical heat exchangers have a ratio of heat exchanger efficiency points to heat exchanger height of about 4 to 6 efficiency points per inch. As it is desired, however, to make furnaces smaller, it is desired to make a smaller heat exchanger which has an increased efficiency over heat exchangers of a similar height.

### BRIEF DESCRIPTION OF THE INVENTION

According to one aspect of the invention, a primary heat exchanger for a furnace includes one or more passes and having a heat exchanger height. A ratio of heat exchanger efficiency to heat exchanger height is in the range of about 7.0 points per inch to about 8.1 points per inch.

According to another aspect of the invention, a furnace includes a burner for combusting a fuel and a primary heat exchanger operably connected to the burner. The primary heat exchanger includes one or more passes and has a heat exchanger height. A ratio of heat exchanger efficiency to heat exchanger height is in the range of about 7.0 points per inch to about 8.1 points per inch.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a graph illustrating heat exchanger efficiency versus heat exchanger height for typical heat exchangers; and

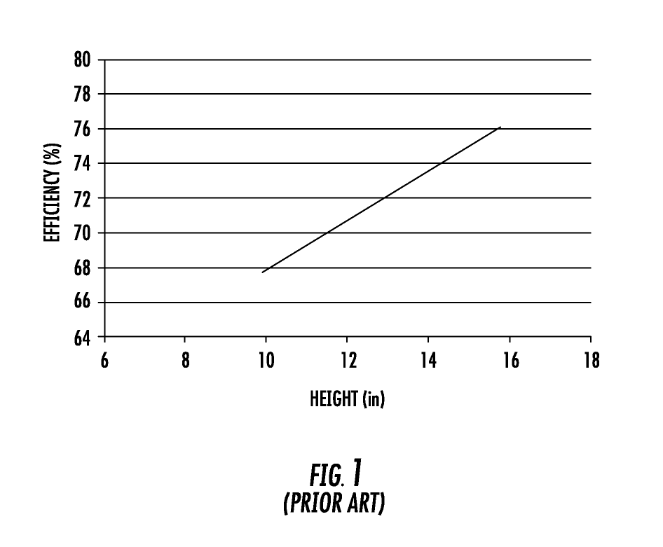

FIG. 2 is a schematic view of an embodiment of a furnace.

The detailed description explains embodiments of the invention, together with advantages and features, by way of example with reference to the drawings.

### DETAILED DESCRIPTION OF THE INVENTION

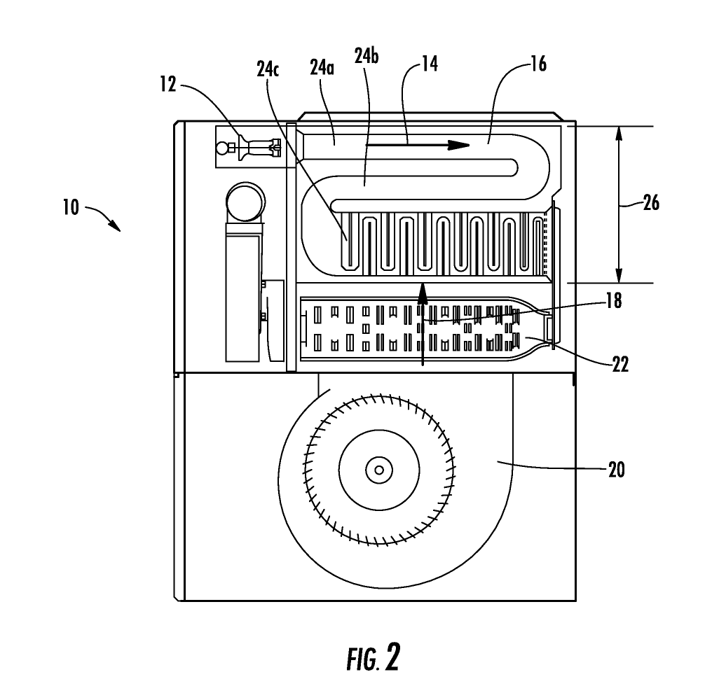

Shown in FIG. 2 is an embodiment of a furnace 10. The furnace 10 includes a burner 12 for combusting a fuel such as natural gas or propane. The burner 12 in some embodiments has an input rate of 18,000 to 22,000 BTU/hr. Flue gas 14 exits the burner 12 and flows through a primary heat exchanger (PHX) 16. The PHX 16 is a gas-to-gas heat exchanger in which the flue gas 14 flowing through the PHX 16 transfers thermal energy to the surface of the PHX 16. The thermal energy is then dissipated from the surface of the PHX 16 into a flow of air 18 urged across the exterior of the PHX 16 by, for example, a blower 20. At an exit of the PHX 16, a temperature of the surfaces of the PHX 16 are still at a level that exceeds a dew point temperature at which moisture will condense out of the flue gas 14. The flue gas 14 then flows through a condensing heat exchanger (CHX) 22 in which the temperature of the surfaces of the CHX 22 are lowered below the dew point further removing thermal energy from the flue gas 14.

The PHX 16 is configured with one or more passes 24, or legs, through which the flue gas 14 passes in a serpentine path through the PHX 16. In some embodiments, as shown in FIG. 2, the PHX 16 includes three passes 24. A first pass 24a and a second pass 24b extend substantially linearly across a width of the PHX 16, while a third pass 24c extends in a labyrinthine manner across the PHX 16. Further, the third pass 24c may include irregularities which in some embodiments are unidirectional, for example, corrugations, or in other embodiments are multidirectional. The irregularities are disposed along a length of the third pass 24c. The PHX 16, when the burner 12 is operating with approximately 63% excess air of combustion, a furnace temperature rise of 55 degrees Fahrenheit, and an input flow rate of about 18,000 to 22,000 BTU/hr has an efficiency in the range of about 78% to 79%. When operating at 40% excess air, the resulting efficiency is about 78.5% to 79.4%. The resulting PHX 16 has a height 26 much shorter than prior art heat exchangers of comparable efficiency. In some embodiments, the height 26 is in the range of about 10 to about 10.7 inches and in one embodiment is about 10.63 inches, and has a ratio of efficiency to height in the range of about 7.0 to 7.9 efficiency points per inch. The PHX 16 configured as such contributes to a furnace 10 of reduced size to fit into a smaller location and utilize less material, resulting in a lower cost PHX 16, while retaining or exceeding the efficiency and operating capabilities desired.

In an alternative embodiment, the PHX 16 includes a first portion having 2-passes, and transition to a second portion which includes a bifurcated 3rd pass. This embodiment has a height 26 of about 9.5 to 10.2 inches and an efficiency of about 76.9% when operated at 63% excess air of combustion, a furnace temperature rise of 55 degrees Fahrenheit, and at a flow rate of about 18,000 to 22,000 BTU/hr. This results in ratio of efficiency to height of about 7.5 to about 8.1.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A primary heat exchanger for a furnace comprising one or more passes and having a heat exchanger height wherein a ratio of heat exchanger efficiency to heat exchanger height is in the range of about 7.0 points per inch to about 8.1 points per inch.

2. The primary heat exchanger of claim 1, wherein the furnace has an input rate of about 18,000 to 22,000 BTU per hour.

3. The primary heat exchanger of claim 1, wherein the heat exchanger height is between about 9.5 and 10.7 inches.

4. The primary heat exchanger of claim 1, wherein the one or more passes is three passes.

5. The primary heat exchanger of claim 4, wherein a third pass of the three passes includes a plurality of irregularities extending at least partially along a length of the third pass.

6. The primary heat exchanger of claim 4, wherein a third pass of the three passes is substantially bifurcated.

7. The primary heat exchanger of claim 1, wherein the heat exchanger efficiency is between about 75 percent and 79.4 percent.

8. A furnace comprising:
a burner for combusting a fuel; and
a primary heat exchanger operably connected to the burner including one or more passes and having a heat exchanger height wherein a ratio of heat exchanger efficiency to heat exchanger height is in the range of about 7.0 points per inch to about 8.1 points per inch.

9. The furnace of claim 8, wherein the burner has an input rate of about 18,000 to 22,000 BTU per hour.

10. The furnace of claim 8, wherein the heat exchanger height is between about 9.5 and 10.7 inches.

11. The furnace of claim 8, wherein the one or more passes is three passes.

12. The furnace of claim 11, wherein a third pass of the three passes includes a plurality of irregularities extending at least partially along a length of the third pass.

13. The furnace of claim 11, wherein a third pass of the three passes is substantially bifurcated.

14. The furnace of claim 8, wherein the heat exchanger efficiency is between about 75 percent and 79.4 percent.

15. The furnace of claim 8, wherein the fuel is natural gas or propane.
